(19) United States
(12) Patent Application Publication
(10) Pub. No.: US 2025/0073819 A1
(43) Pub. Date: Mar. 6, 2025

(54) Laser Cleaning Used Component of Substrate Processing Chamber

(71) Applicant: Applied Materials, Inc., Santa Clara, CA (US)

(72) Inventors: Chunrong YIN, Palo Alto, CA (US); Ching-Pao WANG, Hsinchu (TW); Joseph LIU, Hsinchu City (TW); Yixing LIN, Saratoga, CA (US); Boon Sen CHAN, Singapore (SG); Siamak SALIMIAN, Los Altos, CA (US)

(21) Appl. No.: 18/242,184

(22) Filed: Sep. 5, 2023

(51) Int. Cl. B23K 26/352; B23K 26/082; B23K 26/40

(52) U.S. Cl. CPC B23K 26/3568; B23K 26/082; B23K 26/40; B23K 2103/52

(57) ABSTRACT

Methods and apparatus for cleaning a used component from a substrate processing chamber are provided. In some embodiments, the method includes obtaining a used component having a ceramic base and process residue that is generated as a byproduct in the substrate processing chamber and that is in direct contact with the ceramic base; and at least partially removing the process residue by scanning a laser beam across the process residue.

### FIELD

Embodiments of the present disclosure generally relate to cleaning of substrate processing components, and more particularly to an apparatus and methods for cleaning components with a laser.

### BACKGROUND

Some substrate processing chambers include components (e.g., an electrostatic chuck) that may have a ceramic base. During substrate processing in a substrate processing chamber, the ceramic base of the components may become directly contacted with residue of the byproducts of the substrate processing operations.

Wet cleaning and polishing has been used to clean some used components of substrate processing chambers. However, wet cleaning and polishing can cause outgassing upon reusing the wet cleaned and polished components. Also, wet cleaning and polishing can cause changes to the morphology and properties of the ceramic base of the components or can cause pitting of the ceramic base.

Thus, what is needed is an apparatus and method for cleaning used components of substrate processing chambers that can remove the residue without outgassing and without altering or damaging the ceramic base.

### SUMMARY

Methods and apparatus for cleaning a used component from a substrate processing chamber are provided herein. In some embodiments, a method for cleaning a used component from a substrate processing chamber includes obtaining a used component having a ceramic base and process residue that is generated as a byproduct in the substrate processing chamber and that is in direct contact with the ceramic base; and at least partially removing the process residue by scanning a laser beam across the process residue.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a schematic of a system for cleaning a used component from a substrate processing chamber in accordance with some embodiments of the present disclosure.

FIG. 2 is a method for cleaning a used component from a substrate processing chamber in accordance with some embodiments of the present disclosure.

FIG. 3 shows a block diagram of an exemplary computer system that may be used in conjunction with some embodiments of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of a system and method for cleaning a used component from a substrate processing chamber are provided herein. The used component may be a component used in various types of substrate processing chambers, including etch, ALD, PVD and CVD chambers. The used component has a ceramic base and a process residue in direct contact with the ceramic base. The ceramic base may be a bulk, coating, or layer of the used component. The process residue may be a byproduct of substrate processing in the substrate processing chamber. In some embodiments, used components may include at least one of liners, lids, chucks, susceptors, as well as any other component of a substrate processing chamber having a ceramic base that is in direct contact with process residue. The embodiments described herein use laser scanning to remove at least some of the process residue from the used component to clean the used component. The laser scanning in accordance with some embodiments can remove the process residue without subsequent outgassing after using the cleaned component and without altering or damaging the ceramic base.

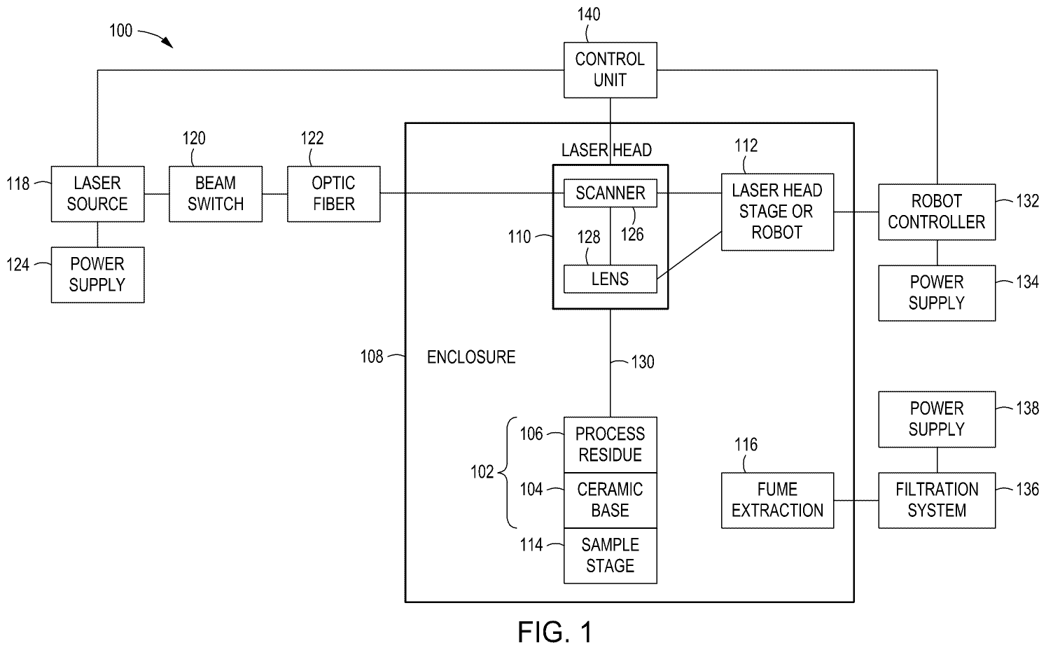

FIG. 1 is a schematic of a system 100 for cleaning a used component 102 from a substrate processing chamber in accordance with some embodiments of the present disclosure. In some embodiments, and a shown in FIG. 1, the used component 102 includes a ceramic base 104 and a process residue 106 in direct contact with ceramic base 104. As noted above, the ceramic base 104 may be a bulk, coating, or layer of the used component 102. The system 100 may include a chamber 108 to house the used component 102 during a cleaning operation, described in greater detail below. In some embodiments, and as shown in FIG. 1, within the chamber 108 the system 100 may include a laser head 110, a robot 112, a sample stage 114, and a fume extraction system 116. The robot 112 may support the laser head 110 and the robot 112 may be supported by the chamber 108. The sample stage 114 may support the used component 102 when the used component is cleaned in the chamber 108. The sample stage 114 may be stationary or maymove the used component 102 during laser scanning.

In some embodiments, and as shown in FIG. 1, the fume extraction system 116 may be configured to extract gases, particles, and/or dust that may be generated as a result of laser ablation of the process residue 106 as described in greater detail below. In some embodiments, and as shown in FIG. 1, the system 100 may include a filtration system 136 connected to the fume extraction system 116. The system 100 may include a power supply 138 that may be configured to supply power to at least one of the fume extraction system 116 and the filtration system 136.

In some embodiments, and as shown in FIG. 1, the system 100 may include a laser source 118, beam switch 120, optic fiber 122, and power supply 124 connected to the laser head 110. The power supply 124 may be configured to supply power to at least one of the laser source 118, beam switch 120, or laser head 110. In some embodiments, and as shown in FIG. 1, the laser head 110 may include a scanner 126 and optics 128 (e.g., a lens). The scanner 126 may be configured to move a laser beam 130 in one-dimensional or two-dimensional manner. Optics 128 may be interchangeable to change the focal distance and scan area size. The laser source 118 may be configured to generate laser light of a certain power, wavelength, pulse duration and pulse frequency transmitted through the beam switch 120 and optic fiber 122 to the laser head 110. The laser head 110 may be configured to receive the laser light transmitted from the laser source 118 and emit the laser beam 130 towards the used component 102, and more specifically, towards the process residue 106. In some embodiments, the laser head 110 may be configured to emit a laser beam 130 having energy density based on at least one of the process residue 106 or the ceramic base 104. In some embodiments, the laser beam has an energy density sufficient to ablate the process residue 106 without altering the morphology or otherwise damaging (e.g., causing pitting, cracking) the ceramic base 104. In some embodiments, the laser beam 130 may have a power of about 10 watts to 1000 watts. In some embodiments, the laser beam 130 may have a power density of about 1×10⁴ W/cm² to 8×10⁶ W/cm².

In some embodiments, the robot 112 may be configured to move the laser head 110 and laser beam 130 relative to the used component 102. In some embodiments, the robot 112 may be configured to move the laser head 110 in three orthogonal directions in the chamber 108. In some embodiments, the robot 112 may be configured to rotate the laser head 110 to alter an incidence angle of the laser beam 130 relative to the used component 102.

In some embodiments, and as shown in FIG. 1, the system 100 may include a robot controller 132 connected (e.g., via wired or wireless connection) to the robot 112. The robot controller 132 may be configured to control the movement of the robot 112, and, in turn, the laser head 110. The system 100 may include a power supply 134 to supply power to at least one of the robot 112 or the robot controller 132.

In some embodiments, and as shown in FIG. 1, the system 100 may include a controller 140 connected (e.g., via wired or wireless connection) to the laser source 118, the robot controller 132, and the laser head 110. The controller 140 may be configured to configure and/or control the laser source 118, the laser head 110, and the robot controller 132 to control the power density and motion of the laser head 110 and the laser beam 130 during a cleaning operation described in greater detail below.

In some embodiments, the controller 140 may be configured to control various parameters of the laser source 118, including power, wavelength, pulse duration, and pulse frequency. In some embodiments, the controller 140 may be configured to control various parameters of the laser head 110 including scan frequency, scan width, beam size, focus distance, and spot size. In some embodiments, the control unit may be configured to control various parameters of the robot 112 including at least one of speed, working distance, position, and incidence angle of the laser beam 130 relative to the used component 102.

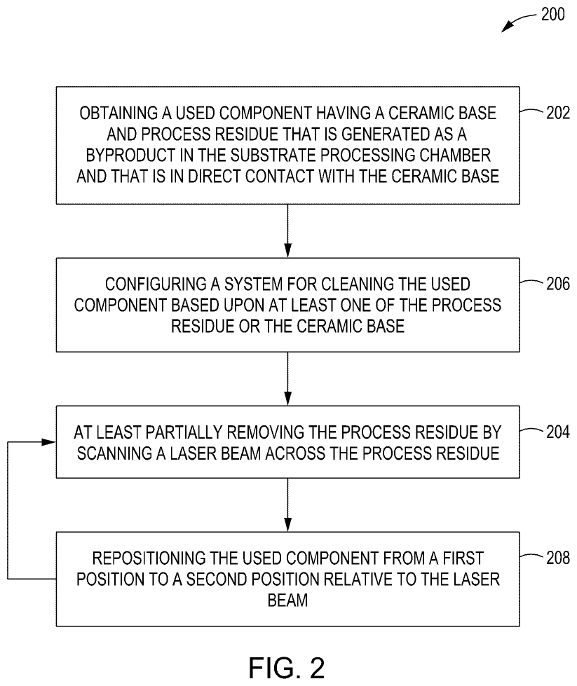

FIG. 2 shows a method 200 for cleaning a used component (e.g., used component 102) from a substrate processing chamber according to some embodiments of the present disclosure. In some embodiments, and as shown in FIG. 2, at block 202 the method 200 may include obtaining a used component (e.g., used component 102) having a ceramic base (e.g., ceramic base 104) and process residue (e.g., process residue 106) that is generated as a byproduct in the substrate processing chamber and that is in direct contact with the ceramic base. In some embodiments, and as shown in FIG. 2, at block 204 the method 200 may include at least partially removing the process residue by scanning a laser beam (e.g., laser beam 130) across the process residue.

In some embodiments, scanning may include controlling at least one of motion, energy density, or power density of the laser beam across the process residue 106 based on at least one of the ceramic base 104 or the process residue 106. In some embodiments, scanning may include controlling at least one of the power, the number of scanning repetitions (e.g., scanning passes), beam area, scan frequency, scan width, or robot speed.

In some embodiments, the method 200 may include controlling the energy density of the laser beam 130 across the process residue 106 during scanning. Energy density may be calculated as:

$$Energy Density ( \frac{J}{{cm}^{2}} ) = \frac{Power ( W )}{Pulse Frequency ( Hz ) \times Beam Area ( {cm}^{2} )} , \qquad ( 1 )$$

where power is the pre-selected power, the pulse frequency is pulse repletion rate of the laser emitting from laser source 118, and beam area is the smallest cross sectional area of the laser beam 130 at the focal plane. In some embodiments, the controller 140 may control the energy density by controlling the above-noted parameters of at least one of the laser source 118 or the laser head 110 and may control the distance of the laser head 110 relative to the used component 102 and the incidence angle of the laser beam 130 within the chamber 108. In some embodiments, the laser beam 130 has a sufficient energy density to ablate the process residue 106 as the laser beam 130 scans the process residue 106 without ablating the ceramic base 104.

In some embodiments, the method 200 may include controlling power density during scanning, which may be defined as:

$$Power Density ( \frac{W}{{cm}^{2}} ) = \frac{Power ( W )}{Beam Area ( {cm}^{2} )} = Energy Density \times Pulse Frequency \qquad ( 2 )$$

In some embodiments, the laser beam 130 may have a power density of about 1×10⁴ W/cm²−8×10⁶ W/cm².

In some embodiments, at 206, the method 200 may include, before scanning, configuring a system, such as system 100, based upon at least one of the process residue 106 or the ceramic base 104. In some embodiments, configuring the system 100 may include setting initial control parameters of at least one of the laser source 118, beam switch 120, laser head 110, and robot 112 of the system 100 to provide a laser beam 130 having an energy density sufficient to ablate the process residue 106 without ablating the ceramic base 104. In some embodiments, at least one of the power, the number of scanning repetitions (e.g., scanning passes), beam size area, scan frequency, scan width, and robot speed may be set based on at least one of the ceramic base 104 or the process residue 106.

In some embodiments, the scanning may be processed in different patterns including at least one of directional, bidirectional, crosshatch, or spiral. In some embodiments, the total removal of the process residue 106 of the used component 102 may be achieved by one pass of scanning. In some embodiments, scanning may be performed in multiple passes to remove some or all of the process residue 106 in multiple stages. As noted above, in some embodiments, the scanning may be performed in various patterns, such as alternating directions (e.g., back and forth). In some embodiments, the laser beam 130 may be moved using the robot 112 at a speed of 1 mm/sec-100 mm/sec with respect to the used component 102. In some embodiments, the laser beam 130 may have a wavelength of 300 nm-1100 nm. In some embodiments, the laser beam 130 may have a wavelength of less than 300 nm or greater than 1100 nm. In some embodiments, the beam size may be between 50 um and 1000 um. In some embodiments, the beam size may be less than 50 um or greater than 1000 um.

In some embodiments, the ceramic base 104 may include at least one of yttrium oxide (YO), silicon carbide (SiC), aluminum oxide (Al₂O₃) or aluminum nitride (AlN). In some embodiments, the process residue 106 may include at least one of a carbon layer, polymer layer, fluorinated material, silicon nitride (SiN), metallic or oxidized metallic layer.

In some embodiments, the used component 102 may have a ceramic base 104 that includes yttrium oxide (YO) and process residue 106 that includes a fluorinated material (e.g., YOF). In some embodiments, the used component 102 may be at least one of a liner or a lid having a ceramic base 104 that includes yttrium oxide and having process residue 106 that includes a fluorinated material, and the scanning may fully remove the process residue 106 leaving an exposed surface of the ceramic base 104 with a surface roughness that may be the surface roughness of the ceramic base 104 before deposition of process residue 106 on the ceramic base 104 before substrate processing. In some embodiments, scanning fully removes the process residue 106 leaving an exposed surface of the ceramic base 104 with a surface roughness of less than 200 μin.

In some embodiments, the used component 102 may have a ceramic base 104 that may include silicon carbide (SiC) and process residue 106 that may include silicon nitride (SiN). The scanning may fully remove the process residue 106 leaving an exposed surface of the ceramic base 104 with a surface roughness that may be the surface roughness of the ceramic base 104 before deposition of process residue 106 on the ceramic base 104 before substrate processing. In some embodiments, scanning fully removes the process residue 106 leaving an exposed surface of the ceramic base 104 with a surface roughness of 30 μin-200 μin.

In some embodiments, the used component 102 may have a ceramic base 104 that may include aluminum oxide (Al₂O₃) or aluminum nitride (AlN) and a process residue 106 that may include titanium. In some embodiments, the used component 102 may be a chuck (e.g., electrostatic chuck) having a ceramic base 104 that includes aluminum oxide or aluminum nitride and having a process residue 106 that includes titanium, and scanning may fully remove the process residue 106 leaving an exposed surface of the ceramic base 104 with a surface roughness that may be the surface roughness of the ceramic base 104 before deposition of process residue 106 on the ceramic base 104 before substrate processing. In some embodiments, scanning fully removes the process residue 106 leaving an exposed surface of the ceramic base 104 with a surface roughness of less than 5 μin.

In some embodiments, at block 208, the method 200 may include repositioning the used component 102 from a first position to a second position relative to the laser beam 130 and repeating the scanning in the second position. For example, the process residue 106 may be on a side of the used component 102 that is blocked from the laser beam 130 by the geometry of the used component 102, the available scan area of scanner 126 or by the reach of the robot 112.

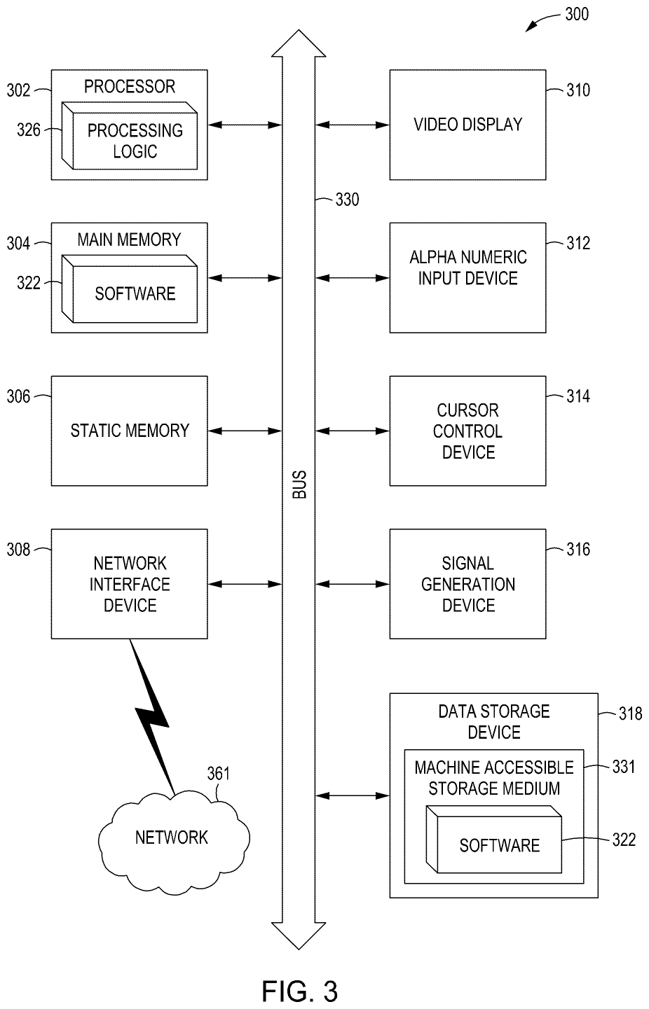

FIG. 3 shows a block diagram of a computer system 300 of a cleaning system (e.g., system 100) illustrated in accordance with some embodiments of the present disclosure. In some embodiments, computer system 300 may provide the functions of at least one of the control 140 or robot controller 132 coupled to the system 100. Computer system 300 may be connected (e.g., networked) to other machines in a network 361 (e.g., a Local Area Network (LAN), an intranet, an extranet, or the Internet). Computer system 300 may operate in the capacity of a server or a client machine in a client-server network environment, or as a peer machine in a peer-to-peer (or distributed) network environment. Computer system 300 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 300, the term “machine” shall also be taken to include any collection of machines (e.g., computers) that individually or jointly execute a set (or multiple sets) of instructions to perform any one or more of the methodologies described herein.

Computer system 300 may include a computer program product, or software 322, having a non-transitory machine-readable medium having stored thereon instructions, which may be used to program computer system 300 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 300 includes a system processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a secondary memory 318 (e.g., a data storage device), which communicate with each other via a bus 330.

System processor 302 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 302 may also be one or more special-purpose processing devices such as an application specific integrated circuit (ASIC), a field programmable gate array (FPGA), a digital signal system processor (DSP), network system processor, or the like. System processor 302 is configured to execute the processing logic 326 for performing the operations described herein.

The computer system 300 may further include a system network interface device 308 for communicating with other devices or machines. The computer system 300 may also include a video display unit 310 (e.g., a liquid crystal display (LCD), a light emitting diode display (LED), or a cathode ray tube (CRT)), an alphanumeric input device 312 (e.g., a keyboard), a cursor control device 314 (e.g., a mouse), and a signal generation device 316 (e.g., a speaker).

The secondary memory 318 may include a machine-accessible storage medium 331 (or more specifically a computer-readable storage medium) on which is stored one or more sets of instructions (e.g., software 322) embodying any one or more of the methodologies or functions described herein. The software 322 may also reside, completely or at least partially, within the main memory 304 and/or within the system processor 302 during execution thereof by the computer system 300, the main memory 304 and the system processor 302 also constituting machine-readable storage media. The software 322 may further be transmitted or received over a network 361 via the system network interface device 308.

While the machine-accessible storage medium 331 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Embodiments described herein provide for laser removal of process residue in direct contact with a ceramic base of a used component of a substrate processing chamber. By removing the process residue without altering or damaging the underlying ceramic base, a desired surface finish of the ceramic base can be obtained.

While the foregoing is directed to embodiments of the present disclosure, other and further embodiments of the disclosure may be devised without departing from the basic scope thereof.

1. A method for cleaning a used component from a substrate processing chamber, the method comprising:
obtaining a used component having a ceramic base and process residue that is generated as a byproduct in the substrate processing chamber and that is in direct contact with the ceramic base; and
at least partially removing the process residue by scanning a laser beam across the process residue.

2. The method of claim 1, wherein scanning includes controlling at least one of motion, energy density, or power density of the laser beam across the process residue.

3. The method of claim 1, wherein the scanning is performed in one or more passes.

4. The method of claim 1, wherein the laser beam has an energy density selected to ablate the process residue but not the ceramic base.

5. The method of claim 1, wherein the laser beam has a power density of about 1×10⁴ W/cm²-8×10⁶ W/cm².

6. The method of claim 1, wherein the laser beam has a power of about 10 watts to 1000 watts.

7. The method of claim 1, wherein the used component includes a liner, a lid, a susceptor, or a chuck.

8. The method of claim 1, wherein the ceramic base includes at least one of yttrium oxide (YO), silicon carbide (SIC), aluminum oxide (Al₂O₃), or aluminum nitride (AlN).

9. The method of claim 1, wherein the process residue includes at least one of a carbon layer, polymer layer, fluorinated material, silicon nitride (SiN), metallic or oxidized metallic layer.

10. The method of claim 1, wherein the ceramic base includes yttrium oxide (YO) and the process residue includes a fluorinated material.

11. The method of claim 10, wherein the used component is at least one of a liner or a lid of the substrate processing chamber.

12. The method of claim 11, wherein the scanning fully removes the process residue leaving an exposed surface of the ceramic base with a surface roughness less than 200 μin.

13. The method of claim 1, wherein the ceramic base includes silicon carbide (SIC) and the process residue includes silicon nitride (SiN).

14. The method of claim 13, wherein the used component is a susceptor of the substrate processing chamber.

15. The method of claim 14, wherein the scanning fully removes the process residue leaving an exposed surface of the ceramic base with a surface roughness of 30 μin-200 μin.

16. The method of claim 1, wherein the ceramic base includes aluminum oxide (Al₂O₃) or aluminum nitride (AlN) and the process residue includes titanium.

17. The method of claim 16, wherein the used component is a chuck of the substrate processing chamber.

18. The method of claim 17, wherein the scanning fully removes the process residue leaving an exposed surface of the ceramic base with a surface roughness of less than 5 μin.

19. The method of claim 1, further comprising repositioning the used component from a first position to a second position relative to the laser beam and repeating the scanning in the second position.

20. The method of claim 1, wherein the laser beam has a wavelength of 300 nm-1100 nm.
